(19) United States
(12) Patent Application Publication
(10) Pub. No.: US 2006/0045985 A1
(43) Pub. Date: Mar. 2, 2006

(54) Method and apparatus for electrostatically coating an ion-exchange membrane or fluid diffusion layer with a catalyst layer

(76) Inventor: Paul D. Kozak, Surrey (CA)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/933,687

(22) Filed: Sep. 2, 2004

(51) Int. Cl. B05D 1/04

(52) U.S. Cl. 427/458

(57) ABSTRACT

A method and apparatus for coating an ion-exchange membrane or fluid diffusion layer with a catalyst layer for use in an electrochemical fuel cell is disclosed, the method comprising the steps of electrostatically charging a catalyst slurry to yield an electrostatically-charged catalyst slurry, and applying the electrostatically-charged catalyst slurry onto a first surface of the ion-exchange membrane or fluid diffusion layer to form a first catalyst layer on the first surface.

### BACKGROUND OF THE INVENTION

1. Field of the Invention

The present invention relates to a method and apparatus for electrostatically coating an ion-exchange membrane or fluid diffusion layer with a catalyst layer for use in an electrochemical fuel cell.

2. Description of the Related Art

Electrochemical fuel cells convert fuel and oxidant to electricity and reaction product. Solid polymer electrochemical fuel cells generally employ a membrane electrode assembly (“MEA”) in which an electrolyte in the form of an ion-exchange membrane is disposed between two electrode layers. The electrode layers are fluid diffusion layers made from porous, electrically conductive sheet material, such as carbon fiber paper or carbon cloth. In a typical MEA, the fluid diffusion layers provide structural support to the membrane, which is typically thin and flexible.

The MEA contains an electrocatalyst, typically comprising finely comminuted platinum particles disposed in a layer at each membrane/electrode layer interface, to induce the desired electrochemical reaction. The electrodes are electrically coupled to provide a path for conducting electrons between the electrodes through an external load.

During operation of the fuel cell, at the anode, the fuel permeates the porous electrode layer and reacts at the anode electrocatalyst layer to form protons and electrons. The protons migrate through the ion-exchange membrane to the cathode. At the cathode, the oxygen-containing gas supply permeates the porous electrode layer and reacts at the cathode electrocatalyst layer with the protons to form water as a reaction product.

Electrocatalyst can be incorporated at the membrane/electrode layer interface in polymer electrolyte fuel cells by applying it as a layer on either an electrode substrate (i.e., fluid diffusion layer) or on the membrane itself. In the former case, electrocatalyst particles are typically mixed with a liquid to form a slurry or ink, which is then applied to the electrode substrate to form a fluid diffusion electrode (FDE). While the slurry preferably wets the substrate surface to an extent, the slurry may penetrate into the substrate such that it is no longer catalytically useful. The reaction zone is generally only close to the ion-exchange membrane. Comparatively lower catalyst loadings can typically be achieved if the ion-exchange membrane is coated. In addition to waste of catalyst material, a thicker electrocatalyst layer may also lead to increased mass transport losses.

Typical methods of preparing a catalyst-coated membrane (CCM) also start with the preparation of a slurry. A slurry typically comprises a carbon-supported catalyst, a polymer matrix/binder and a suitable liquid vehicle such as, for example water, methanol or isopropanol. The slurry is then either directly applied onto the membrane by, for example screen printing, or applied onto a separate carrier or release film from which, after drying, it is subsequently transferred onto the membrane using heat and pressure in a decal-type process. However, there are problems with both of these general techniques. For example, if a slurry is directly applied to the membrane, the liquid vehicle may cause swelling of the membrane by as much as 25% in any direction. While swelling is not typically seen with the decal process, it is comparatively slow and not easily amenable to mass production.

In addition to the foregoing wet deposition techniques, various methods for the deposition of dry catalyst powders onto electrode substrates and membranes have also been developed. Such dry deposition methods include, for example, combustion chemical vapor deposition (CCVD), such as the process described by Hunt et al. in U.S. Pat. No. 6,403,245, and electrostatic powder deposition techniques, such as the process described by Yasumoto et al. in U.S. Pat. No. 6,455,109. However, such dry deposition techniques are highly complex processes, are not easily adaptable to continuous roll-to-roll processing and do not easily maintain uniform loadings.

Accordingly, there remains a need in the art for improved methods for coating ion-exchange membranes and fluid diffusion layers with catalyst layers. The present invention fulfills these needs and provides further related advantages.

### BRIEF SUMMARY OF THE INVENTION

In brief, the present invention is directed to methods and apparatus for electrostatically coating an ion-exchange membrane or fluid diffusion layer with a catalyst layer for use in an electrochemical fuel cell.

In one embodiment, a method is provided for coating an ion-exchange membrane or fluid diffusion layer with a catalyst layer for use in an electrochemical fuel cell, the method comprising the steps of (1) electrostatically charging a catalyst slurry to yield an electrostatically-charged catalyst slurry, and (2) applying the electrostatically-charged catalyst slurry onto a first surface of the ion-exchange membrane or fluid diffusion layer to form a first catalyst layer on the first surface.

In further embodiments, the method comprises the additional steps of heating the catalyst slurry prior to the step of electrostatically charging the catalyst slurry, heating the first surface of the ion-exchange membrane or fluid diffusion layer prior to the step of applying the electrostatically-charged catalyst slurry, and/or drying the first surface of the ion-exchange membrane or fluid diffusion layer following the step of applying the electrostatically-charged catalyst slurry. In specific embodiments of the foregoing, the step of drying the first surface comprises heating the ion-exchange membrane or fluid diffusion layer.

In other further embodiments, the method comprises the additional step of applying the electrostatically-charged catalyst slurry onto the first catalyst layer on the first surface to form a second catalyst layer on top of the first catalyst layer on the first surface.

In yet other further embodiments, the method comprises the additional step of applying the electrostatically-charged catalyst slurry onto a second surface of the ion-exchange membrane or fluid diffusion layer to form a first catalyst layer on the second surface, wherein the second surface is on the opposite side of the ion-exchange membrane or fluid diffusion layer from the first surface.

In certain embodiments, the catalyst slurry comprises a carbon-supported metal catalyst, such as platinum, having a particle size of from about 0.1 μm to about 50 μm or from about 0.1 μm to about 2.0 μm or from about 2 μm to about 10 μm.

In more specific embodiments, a second surface of the ion-exchange membrane or fluid diffusion layer is adjacent to a grounded metal plate, the second surface being on the opposite side of the ion-exchange membrane or fluid diffusion layer from the first surface.

In other more specific embodiments, a second surface of the ion-exchange membrane or fluid diffusion layer is adjacent to a backing sheet, the second surface being on the opposite side of the ion-exchange membrane or fluid diffusion layer from the first surface.

In yet other more specific embodiments, the electrostatically-charged catalyst slurry is sprayed onto the first surface and the catalyst loading of the first catalyst layer is less than about 0.8 mg/cm², less than about 0.5 mg/cm², less than about 0.1 mg/cm², or greater than about 0.015 mg/cm².

These and other aspects of this invention will be evident upon review of the attached figures and following detailed description.

### BRIEF DESCRIPTION OF THE DRAWINGS

FIG. 1 is a cross-sectional view of a membrane electrode assembly.

FIG. 2 schematically illustrates the electrostatic coating of an ion-exchange membrane or fluid diffusion layer with a catalyst layer according to the present invention.

FIG. 3 is a scanning electron micrograph image of a cross-section of an ion-exchange membrane coated with a catalyst layer according to an embodiment of the present invention.

FIGS. 4 is a scanning electron micrograph image of cross-sections of a commercially available Gore 5510 catalyst coated membrane.

### DETAILED DESCRIPTION OF THE INVENTION

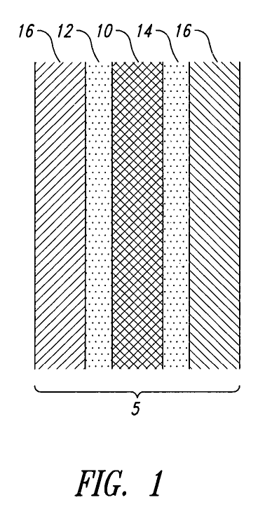

FIG. 1 is a cross-sectional view of a membrane electrode assembly (MEA) 5. MEA 5 comprises an ion-exchange membrane 10 interposed between an anode catalyst layer 12, a cathode catalyst layer 14 and fluid distribution layers 16. Anode and cathode catalyst layers 12, 14 may be coated either on membrane 10, to form a catalyst coated membrane (CCM), or on fluid distribution layers 16, to form two fluid diffusion electrodes.

Fluid distribution layers 16 are electrically conductive and fluid permeable. Electrical conductivity allows for the flow of electrons from the anode to the cathode through an external load. Fluid permeability allows for the supply of fuel and oxidant from fuel and oxidant streams, respectively, to anode and cathode catalyst layers 12, 14, respectively, where the desired electrochemical reactions occurs. Fluid distribution layers 16 typically comprise porous, electrically conductive and fluid permeable pre-formed sheets composed of materials such as, for example, carbon fiber paper, woven or non-woven carbon fabric, metal mesh or gauze, or microporous polymeric film.

The electrocatalyst in catalyst layers 12, 14 may be a metal black, an alloy or a supported metal-based catalyst, such as, for example, platinum supported on carbon particles. Other catalysts include other noble or transition metal catalysts. Catalyst layers 12, 14 may also include an organic binder such as polytetrafluoroethylene (PTFE), polymer electrolyte powder, additives and fillers. Due to the different catalytic reactions occurring during operation of the fuel cell at the anode, as compared to the cathode, anode catalyst layer 12 and cathode catalyst layer 14 typically comprise different catalytic compositions such as, for example, different catalysts, different amounts of catalyst and/or different binders.

Ion-exchange membrane 10 may be, for example, a fluoropolymer containing pendant sulfonic acid functional groups and/or carboxylic acid functional groups. Hydrocarbon based polymers are also well known. The thickness of membrane 10 is commonly 18 to 175 microns, and typically 25 to 125 microns. A representative commercial perfluorosulfonic acid/PTFE copolymer membrane can be obtained from E.I. Du Pont de Nemours and Company under the trade designation NAFION®.

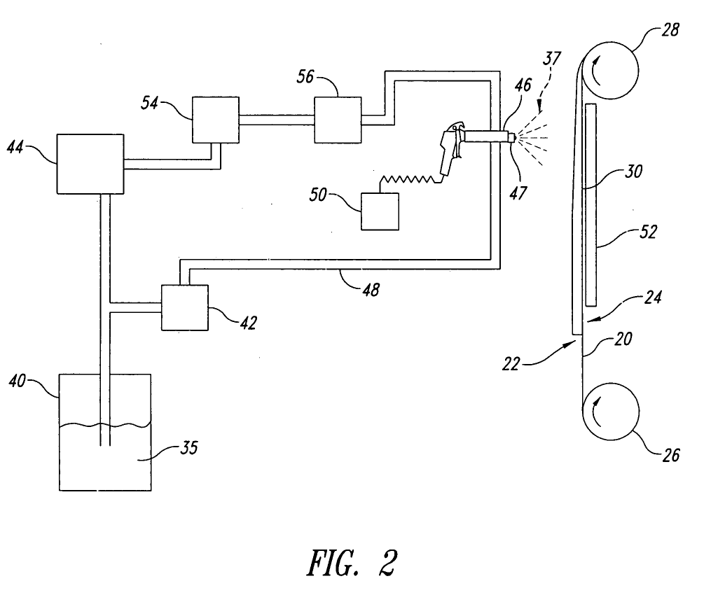

FIG. 2 schematically illustrates one embodiment of the method and apparatus for electrostatically coating an ion-exchange membrane or fluid diffusion layer 20 (hereinafter referred to as substrate 20) with a catalyst layer 30 according to the present invention. As shown, a catalyst slurry 35, comprising the desired electrocatalyst (as described above) and a suitable liquid vehicle (such as, for example, water, methanol, ethanol, isopropanol or a combination thereof), is fed by a circulation valve 42 and a pump 44 from a supply tank 40 to an electrostatic spray gun 46 via a network of pipes 48. Spray gun 46 is electrically connected to a power unit 50 and is configured to impart a negative charge to the electrocatalyst particles (not specifically shown) in catalyst slurry 35 to yield an electrostatically-charged catalyst slurry 37, which is then sprayed onto a first surface 22 of substrate 20 to form a first catalyst layer 30 thereon.

In addition to applying a charge to catalyst slurry 35, electrostatic spray gun 46 may also atomize catalyst slurry 35. In some embodiments, electrostatic spray gun 46 may also use a flow of air to assist the spraying of catalyst slurry 35 onto first surface 22 of substrate 20. Representative commercial electrostatic spray guns are the Aerobell 33, which employs a 33 mm diameter bell type rotary atomizing nozzle, and the Turbodisk, both of which can be obtained from ITW Ransberg. The rotating speed of the nozzle 47 of spray gun 46 directly affects the fineness of the catalyst particle size and may be as high as 60,000 rpm. As shown in FIG. 1, spray gun 46 is positioned such that nozzle 47 is facing first surface 22 of substrate 20. The distance between first surface 22 and nozzle 47 depends on the width of substrate 20 and the angle of the spray from electrostatic spray gun 46 and can easily be determined by a person of ordinary skill in the art. Similarly, the time period for spraying a given area of substrate 20 depends on the mass transfer rate and the target loading and can also easily be varied by a person of ordinary skill in the art. In applying catalyst slurry 35 to first surface 22 of substrate 20, some wraparound onto second surface 24 may be tolerated

In addition, an isolation system (not shown) may be used to provide electrostatic isolation of spray gun 46 from the grounded catalyst slurry 35, particularly when an aqueous solvent is used in catalyst slurry 35. A commercially available isolation system is the AquaBlock isolation system from ITW Ransburg.

In an alternate embodiment (not shown), an inert gas pressurized feed tank may be used instead of pump 44. Similarly, in another alternate embodiment (not shown), spray gun 46 may apply substantially all of catalyst slurry 35 to substrate 20 such that there is no recirculation of catalyst slurry 35 through pipes 48 and therefore no need for circulation valve 42.

As noted above, catalyst slurry 35 comprises the desired electrocatalyst and a suitable liquid vehicle (such as, for example, water, methanol or isopropanol). In certain, more specific embodiments, the electrocatalyst is a carbon-supported metal catalyst, such as platinum, having a particle size of from about 0.1 μm to about 50 μm. When coating on an ion-exchange membrane as substrate 20, a smaller particle size may be desired, for example, from about 0.1 μm to about 2.0 μm. Smaller particle size may allow for more uniform catalyst layers to be applied at lower loadings. This in turn may be expected to produce better adhesion and subsequently higher performance. In addition, smaller particles are also expected to allow better control for achieving the desired loadings. However, when coating on a fluid diffusion layer as substrate 20, a particle size from about 2 μm to about 10 μm may be desired. Fluid diffusion layers tend to be porous and larger particle sizes tend to reduce the amount of penetration of the catalyst into the porous sub-surface. This will expose more active area of the metal catalyst for better performance relative to the degree of loading.

In yet further embodiments, catalyst slurry 35 may also comprise one or more of the following additional components: binder agents, such as polytetrafluoroethylene, Nafion® powders, polyvinyl alcohol, polyvinylidene fluoride, methyl cellulose and the like; surfactants, such as Iconol™ NP-10 from BASF, Surfynol® from ISP, Fluorad™ FC-170C from 3M; anti-settling agents, such as Luvotix™; adhesion promoters, such as methylmethacrylic resin, ethylmethacrylic resin, butylmethacrylic resin, and copolymers; cross-linking agents, such as organic titanates and organic zirconates; Santel HR-97, Doresco® TAW4-39, Resimene AQ1616 and AQ7550. The foregoing additional components may be utilized to promote adhesion between electrostatically-charged catalyst slurry 37 and first surface 22, and to act as dispersants, wetting agents and/or surface tension and viscosity reducing agents. A suitable solids content may be between 5% and 30% with a viscosity of between 1 and 500 cP.

In the illustrated embodiment, electrostatically-charged catalyst slurry 37 is applied to first surface 22 in a continuous process wherein slurry 37 is sprayed onto a moving web of substrate 20 in a reel to reel configuration. As shown, substrate 20 starts in first roll 26 and may be stored in second roll 28 following the application of catalyst layer 30. During the application process, nozzle 47 may either be stationary or be adapted to move in a particular pattern with respect to the exposed portion of first surface 22. As one of skill in the art would appreciate, in alternate embodiments, electrostatically-charged catalyst slurry 37 may instead be applied in a discrete process. For example, nozzle 47 may be adapted to move in a particular pattern with respect to, and thereby coat, a stationary sheet of substrate 20, such as a universal size sheet (approximate dimensions of 665 mm×375 mm).

In electrostatic spray coating, there are a number of variables that can be varied be a person of ordinary skill in the art to optimize the resulting layer. These variables include, but are not limited to: feed pot pressure, charge voltage, substrate velocity, bell rotational rate, shape air pressure, distance from bell to substrate, slurry rheology (viscosity, solids content, etc. . . . ), and the number of passes of the coating over substrate 20.

As further shown in FIG. 2, a second surface 24 of substrate 20, on the opposite side of substrate 20 from both first surface 22 and spray gun 46, may be placed adjacent to a grounded metal plate 52 to further promote adhesion of electrostatically-charged catalyst slurry 37 to first surface 22. For example, in a continuous reel to reel coating process, substrate 20 may be passed adjacent to metal plate 52, and, in a discrete process, a sheet of substrate 20 may be mounted directly on metal plate 52. Metal plate 52 may be of particular benefit when substrate 20 is a non-conductive ion-exchange membrane. Instead of a conductive metal plate 52, a co-flow of close-coupled metal foil may be used in a reel to reel system adjacent second surface 24. The metal foil may be cycled and collected on another roll and re-used. The metal foil may be, for example copper, aluminum or stainless steel and may be, for example, from 15 to 100 μm thick.

It may be difficult to apply coatings on some polymer films due to their inherently low surface energy. An oxidizing technique, such as, for example, a corona treatment can be used to increase the substrate surface-tension. In addition to or instead of such an oxidizing technique, the use of adhesion promoters, high-performance emulsions and surfactants may bond the catalyst ink to the polymer film. Without being bound by theory, a cross-linking mechanism or the removal of a boundary layer may assist with the catalyst-polymer adhesion. Cross-linking may also occur within catalyst slurry 35 itself forming a cohesive bond to improve the film properties. The cross-linking adhesion promoter may also be cured using electron beam, ultraviolet or visible light to polymerize a combination of materials onto substrate 20. Electron beam is a radiant energy source while the energy sources for UV or visible light are typically medium pressure mercury lamps, pulsed xenon lamps or lasers. A conductive adhesion promoter may also be used and may, for example, be applied as a first coat to an ion-exchange membrane using a non-electrostatic spray technique such as airless or assisted airless spraying. This may improve the electrostatic coating of the active, catalyst containing layer and may reduce or even eliminate the benefits of using metal plate 52.

The use of a backing sheet, for example a Mylar® backing sheet, may be used on second surface 24 to provide additional structural support to substrate 20 during coating. Other suitable polymers for a backing sheet include, for example, crystallizable vinyl polymers, condensation polymers and oxidation polymers. Representative crystallizable vinyl polymers include, for example, high and low density polyethylene, polypropylene, polybutadiene, polyacrylates, fluorine-containing polymers such as polyvinylidene fluoride, and corresponding copolymers. Condensations polymers include, for example, polyesters, polyamides and polysulfones. Oxidation polymers include, for example, polyphenylene oxide and polyether ketones. The use of such a backing sheet may be particularly beneficial when used with an ion-exchange membrane as substrate 20.

In other further embodiments, a second catalyst layer (not specifically shown) of electrostatically-charged catalyst slurry 37 may be applied on top of first catalyst layer 30. By applying a number of catalyst layers, the catalyst microstructure may be easily varied which may lead to increased performance.

In yet other further embodiments, wherein substrate 20 is an ion-exchange membrane, after first surface 22 of substrate 20 has been coated with a catalyst layer 30, the same process may be repeated for the other side of substrate 20 to form a first catalyst layer on second surface 24. Alternatively, both sides of substrate 20 may be coated simultaneously.

Heater 54 may be employed to heat catalyst slurry 35 prior to application onto substrate 20 to assist with adhesion and accelerate drying once applied to substrate 20. Heating catalyst slurry 35 also has the advantages of decreasing the viscosity, improving the consistency and reducing the temperature difference between catalyst slurry 35 and substrate 20. Typically, catalyst slurry 35 is pre-heated to a temperature below the boiling point of the solvent system used in catalyst slurry 35. If water is used, catalyst slurry 35 may be pre-heated to as high a temperature as 95° C. In addition, first surface 22 of substrate 20 may also be heated prior to, or dried following, the application of electrostatically-charged catalyst slurry 37 to first surface 22 to further adhesion of catalyst slurry 37 to substrate 20. If substrate 20 is pre-heated, first surface 22 may be pre-heated to a temperature as high as the glass transition temperature of the ion-exchange membrane, for example up to about 150° C. to about 180° C. for NAFION® based membranes. Typical drying temperatures are in the range of 80° C. and 200° C. As one of skill in the art will appreciate, the catalyst layer may crack if the drying rate is too high. Drying may be affected by air movement and humidity. Air movement typically allows heat transfer to substrate 20 and removes solvent from the surface. Rapid removal of solvents can reduce the temperature of the surface which may result in moisture condensation problems. A combination of high humidity and a cooling film can also cause condensation. Suitable heaters for drying include, for example, convection ovens, infrared lamps, microwaves or a combination thereof and may include multiple zones.

In further embodiments, adhesion of the catalyst layer to substrate 20 may be further improved by, for example, applying a slight vacuum on the opposite side of substrate 20 from spray gun 46. A “slight” vacuum may be between 10 and 50 mbar and may result from, for example, a draft fan effect.

Additionally, as shown in FIG. 2, a filter 56 may be employed to remove agglomerates and contaminants in catalyst slurry 35 that would be incompatible with nozzle 47 of spray gun 46.

It has been found that the methods and apparatus of the present invention may be utilized to coat ion-exchange membranes and fluid diffusion layers with catalyst layers having catalyst loadings (i.e., the amount of catalyst per unit area) of less than 0.8 mg/cm², generally less than 0.5 mg/cm², and, in certain embodiments, less than about 0.1 mg/cm². A loading as low as 0.05 mg/cm² and even as low as 0.015 mg/cm² may be possible using the current methods and apparatus. Currently, typical catalyst loading levels are on the order of greater than 1.0 mg/cm². Cost savings can be achieved by reducing catalyst loading levels. Furthermore, the methods and apparatus of the present invention achieve material transfer efficiencies greater than about 80%, which reduces waste.

Post-application processing could include the application of an embedding technique such as, for example, heat-assisted belt bonding on pinch rollers or compression rollers.

An electrostatic coating module or modules could also be easily integrated into conventional reel to reel continuous web processing machinery, including for example a coating line or a double-belt bonding press. Continuous processing speeds of up to 10 m/min could easily be achieved.

The level of catalyst loading can be monitored in a number of ways. For example, X-ray fluorescence (XRF) offers elemental analysis of a wide variety of materials in a highly precise and generally non-destructive way. XRF spectrometers operate by irradiating a sample with a beam of high energy X-rays and exciting characteristic X-rays from those elements present in the sample. The individual X-ray wavelengths are sorted via a system of crystals and detectors, and specific intensities are accumulated for each element. Chemical concentrations of individual elements can then be established by reference to stored calibration data. Alternatively, catalyst loading levels can be determined from the concentration of catalyst in catalyst slurry 35 and by measuring the thickness of the deposited catalyst layer.

The following examples have been included to illustrate different embodiments and aspects of the invention but should not be construed as limiting in any way.

### EXAMPLES

Catalyst Slurry Preparation

50.9 g of HiSPEC 4000 carbon supported platinum catalyst powder was placed into a Morehouse Cowles CM10-0 mixer assembly. The catalyst powder was then degassed for 7 minutes at 320 mbara followed by an additional 7 minutes at 80 mbara. The catalyst powder was then removed from the mixer assembly and 717.8 g deionized water was placed into the mixer assembly and heated to 50±2° C. Approximately one quarter of the catalyst powder was placed into the heated water and mixed at 2000 rpm for 2.5 minutes. Additional catalyst powder was then added in one quarter increments followed by mixing until all of the catalyst powder had been added to the mixture. A vacuum was then applied to the mixture of 320 mbara and the mixture was mixed at 2000 rpm for 10 minutes.

132.8 g aqueous Nafion® (11.3 wt % solid) from DuPont was then added to the mixture. A vacuum was then applied to the mixture of 320 mbara and mixed at 3000 rpm for 35 minutes while maintaining the temperature at 50±2° C. The mixing speed was then reduced to 1000 rpm and the temperature was reduced to 25° C. and the mixture was mixed for 25 minutes.

The resulting mixture had a solids content of 7.3 wt %. When a reduced solids content of 6 wt % was desired, an appropriate amount of deionized water was added to the mixture and mixed at 1000 rpm for 5 minutes at room temperature.

Trial 1

A carbon sublayer was applied to a Toray TGP-60 teflonated to 6 wt % carbon paper to form a fluid diffusion layer with a dry weight of 24.3 g. A catalyst slurry as prepared above (7.3 wt % solids) was then fed to an Aerobell 33 spray gun with a feed pot pressure of 10 psig, slurry flow rate 277 g/min at a voltage of 85 kV and a current draw of 60 μA. The bell speed of the spray gun was set at 35,000 rpm with a 35 psig shape air. The distance from the spray gun to the fluid diffusion layer was 12 inches and the conveyor speed for the fluid diffusion layer was set at 6.4 ft/min. The fluid diffusion layer was subjected to a single pass of the electrostatic spray coater to give a catalyst loading of 0.25 mg/cm².

Trial 2

A carbon sublayer was applied to a Toray TGP-60 teflonated to 6 wt % carbon paper to form a fluid diffusion layer with a dry weight of 23.9 g. A catalyst slurry as prepared above (7.3 wt % solids) was then fed to an Aerobell 33 spray gun with a feed pot pressure of 10 psig, slurry flow rate 277 g/min at a voltage of 85 kV and a current draw of 60 μA. The bell speed of the spray gun was set at 35,000 rpm with a 35 psig shape air. The distance from the spray gun to the fluid diffusion layer was 12 inches and the conveyor speed for the fluid diffusion layer was set at 15.4 ft/min. The fluid diffusion layer was subjected to two passes of the electrostatic spray coater to give a catalyst loading of 0.25 mg/cm².

With a faster conveyor speed of 15.4 ft/min as compared to 6.4 ft/min as in trial 1, two passes were needed to obtain the same catalyst loading. It can thus be assumed that each single pass gave a catalyst loading of 0.12-0.13 mg/cm².

Trial 3

A carbon sublayer was applied to a Toray TGP-60 teflonated to 6 wt % carbon paper to form a fluid diffusion layer with a dry weight of 23.8 g. A catalyst slurry as prepared above (7.3 wt % solids) was then fed to an Aerobell 33 spray gun with a feed pot pressure of 10 psig, slurry flow rate 277 g/min at a voltage of 85 kV and a current draw of 60 μA. The bell speed of the spray gun was set at 35,000 rpm with a 35 psig shape air. The distance from the spray gun to the fluid diffusion layer was 12 inches and the conveyor speed for the fluid diffusion layer was set at 15.4 ft/min. The fluid diffusion layer was subjected to three passes of the electrostatic spray coater to give a catalyst loading of 6.34 mg/cm². Each pass of the spray coater thus gave a loading of approximately 0.11 mg/cm².

Trial 4

A carbon sublayer was applied to a Toray TGP-60 teflonated to 6 wt % carbon paper to form a fluid diffusion layer with a dry weight of 24.4 g. A catalyst slurry as prepared above (7.3 wt % solids) was then fed to an Aerobell 33 spray gun with a feed pot pressure of 8.5-9.0 psig, slurry flow rate 175 g/min at a voltage of 85 kV and a current draw of 60 μA. The bell speed of the spray gun was set at 35,000 rpm with a 35 psig shape air. The distance from the spray gun to the fluid diffusion layer was 12 inches and the conveyor speed for the fluid diffusion layer was set at 15.4 ft/min. The fluid diffusion layer was subjected to three passes of the electrostatic spray coater to give a catalyst loading of 0.15 mg/cm². Each pass of the spray coater thus gave a loading of approximately 0.05 mg/cm².

Trial 5

A carbon sublayer was applied to an Avcarb™ P50T carbon paper from Ballard Material Products Inc. to form a fluid diffusion layer with a dry weight of 21.9 g. A catalyst slurry as prepared above (6 wt % solids) was then fed to an Aerobell 33 spray gun with a feed pot pressure of 10 psig, slurry flow rate 200 g/min at a voltage of 85 kV and a current draw of 60 μA. The bell speed of the spray gun was set at 35,000 rpm with a 30 psig shape air. The distance from the spray gun to the fluid diffusion layer was 12 inches and the conveyor speed for the fluid diffusion layer was set at 15.4 ft/min. The fluid diffusion layer was subjected to two passes of the electrostatic spray coater to give a catalyst loading of 0.18 mg/cm². Each pass of the spray coater thus gave a loading of approximately 0.09 mg/cm².

Trial 6

A carbon sublayer was applied to an Avcarb™ P50T carbon paper from Ballard Material Products Inc. to form a fluid diffusion layer with a dry weight of 21.6 g. A catalyst slurry as prepared above (6 wt % solids) was then fed to an Aerobell 33 spray gun with a feed pot pressure of 8.5-9.0 psig, slurry flow rate 175 g/min at a voltage of 85 kV and a current draw of 60 μA. The bell speed of the spray gun was set at 35,000 rpm with a 30 psig shape air. The distance from the spray gun to the fluid diffusion layer was 12 inches and the conveyor speed for the fluid diffusion layer was set at 15.4 ft/min. The fluid diffusion layer was subjected to three passes of the electrostatic spray coater to give a catalyst loading of 0.10 mg/cm². Each pass of the spray coater thus gave a loading of approximately 0.03 mg/cm².

Trial 7

A Nafion® 112 ion-exchange membrane from DuPont with a dry weight of 29.3 g was used as the substrate. A catalyst slurry as prepared above (6 wt % solids) was then fed to an Aerobell 33 spray gun with a feed pot pressure of 7.0-6.0 psig, slurry flow rate 158 g/min at a voltage of 85 kV and a current draw of 60 μA. The bell speed of the spray gun was set at 35,000 rpm with a 30 psig shape air. The distance from the spray gun to the ion-exchange membrane was 10 inches and the conveyor speed for the fluid diffusion layer was set at 15.4 ft/min. The ion-exchange membrane was subjected to one pass of the electrostatic spray coater on a first side of the membrane and two passes on a second side of the membrane. The catalyst loadings were estimated to be between 0.06 and 0.10 mg/cm² on each side. A thin polymer backing support layer was left on the membrane during coating of the first side of the membrane. During coating of the second side of the membrane, structural integrity of the ion-exchange membrane appeared to be compromised. Significant improvements were observed with the use of a backing support.

Trial 8

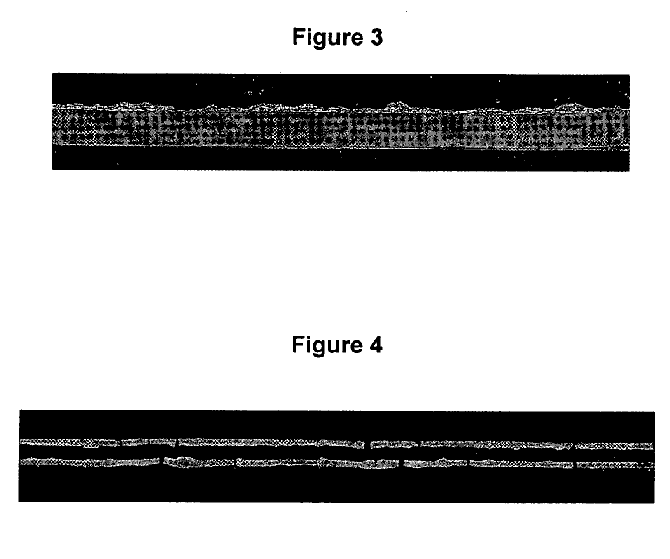

A Nafion® 112 ion-exchange membrane from DuPont was used as the substrate. A catalyst slurry as prepared above (6 wt % solids) was then fed to an Aerobell 33 spray gun with a feed pot pressure of 7.0-6.0 psig, slurry flow rate 158 g/min at a voltage of 85 kV and a current draw of 60 μA. The bell speed of the spray gun was set at 35,000 rpm with a 30 psig shape air. The distance from the spray gun to the ion-exchange membrane was 10 inches and the conveyor speed for the fluid diffusion layer was set at 15.4 ft/min. The ion-exchange membrane was subjected to four passes of the electrostatic spray coater on a single side of the membrane to give a catalyst loading of 0.25 mg/cm². Each pass of the spray coater thus gave a loading of approximately 0.06 mg/cm². A thick polymer backing support layer was left on the membrane during coating of the first side of the membrane. A scanning electron micrograph image was then taken of the coated ion-exchange membrane and is shown as FIG. 3.

Trial 9

A Nafion® 111 ion-exchange membrane from DuPont with a dry weight of 23.2 g was used as the substrate. A catalyst slurry as prepared above (6 wt % solids) was then fed to an Aerobell 33 spray gun with a feed pot pressure of 6.0-6.5 psig, slurry flow rate 150 g/min at a voltage of 85 kV and a current draw of 60 μA. The bell speed of the spray gun was set at 35,000 rpm with a 30 psig shape air for coating a first side of the membrane and a 20 psig shape air for coating a second side of the membrane. The distance from the spray gun to the ion-exchange membrane was 10 inches and the conveyor speed for the fluid diffusion layer was set at 15.4 ft/min. The ion-exchange membrane was subjected to four passes of the electrostatic spray coater on each side of the membrane to give a catalyst loading of 0.07 mg/cm² on each side. Each pass of the spray coater thus gave a loading of approximately 0.017 mg/cm².

Trial 10

A Nafion® 115 ion-exchange membrane from DuPont with a dry weight of 26.64 g was used as the substrate. A catalyst slurry as prepared above (6 wt % solids) was then fed to an Aerobell 33 spray gun with a feed pot pressure of 6.0-6.5 psig, slurry flow rate 150 g/min at a voltage of 85 kV and a current draw of 60 μA. The bell speed of the spray gun was set at 35,000 rpm with a 30 psig shape air for coating a first side of the membrane and a 20 psig shape air for coating a second side of the membrane. The distance from the spray gun to the ion-exchange membrane was 10 inches and the conveyor speed for the fluid diffusion layer was set at 11 ft/min. The ion-exchange membrane was subjected to four passes of the electrostatic spray coater on each side of the membrane to give a catalyst loading of 0.06 mg/cm² on each side. Each pass of the spray coater thus gave a loading of approximately 0.015 mg/cm².

All of the substrates in Trials 1-10 were at room temperature and not pre-heated.

Comparison to Commercial CCM

FIG. 4 is a scanning electron microscope image of a series 5510 catalyst coated membrane from Gore. The ion-exchange membrane is 25 μm thick and coated on both sides with a catalyst layer. In comparison, the ion-exchange membrane of Trial 8 is a 50 μm thick membrane coated with a catalyst layer on one side. Visual inspection of the catalyst layers on the different membranes clearly shows that the catalyst layer in FIG. 3 is significantly thinner and contains fewer cracks.

While particular steps, elements, embodiments and applications of the present invention have been shown and described herein for purposes of illustration, it will be understood, of course, that the invention is not limited thereto since modifications may be made by persons skilled in the art, particularly in light of the foregoing teachings, without deviating from the spirit and scope of the invention. Accordingly, the invention is not limited except as by the appended claims.

What is claimed is:

1. A method for coating an ion-exchange membrane or fluid diffusion layer with a catalyst layer for use in an electrochemical fuel cell, the method comprising the steps of:
electrostatically charging a catalyst slurry to yield an electrostatically-charged catalyst slurry; and
applying the electrostatically-charged catalyst slurry onto a first surface of the ion-exchange membrane or fluid diffusion layer to form a first catalyst layer on the first surface.

2. The method of claim 1 further comprising the step of:
heating the catalyst slurry prior to the step of electrostatically charging the catalyst slurry.

3. The method of claim 1 further comprising the step of:
heating the first surface of the ion-exchange membrane or fluid diffusion layer prior to the step of applying the electrostatically-charged catalyst slurry.

4. The method of claim 1 further comprising the step of:
drying the first surface of the ion-exchange membrane or fluid diffusion layer following the step of applying the electrostatically-charged catalyst slurry.

5. The method of claim 4, wherein the step of drying the first surface comprises heating the ion-exchange membrane or fluid diffusion layer.

6. The method of claim 1 further comprising the step of:
applying the electrostatically-charged catalyst slurry onto the first catalyst layer on the first surface to form a second catalyst layer on top of the first catalyst layer on the first surface.

7. The method of claim 1 further comprising the step of:
applying the electrostatically-charged catalyst slurry onto a second surface of the ion-exchange membrane or fluid diffusion layer to form a first catalyst layer on the second surface, wherein the second surface is on the opposite side of the ion-exchange membrane or fluid diffusion layer from the first surface.

8. The method of claim 1 wherein the catalyst slurry comprises a carbon-supported metal catalyst.

9. The method of claim 8 wherein the metal is platinum.

10. The method of claim 8 wherein the metal catalyst has a particle size of from about 0.1 μm to about 50 μm.

11. The method of claim 10 wherein the metal catalyst has a particle size of from about 0.1 μm to about 2.0 μm.

12. The method of claim 10 wherein the metal catalyst has a particle size of from about 2 μm to about 10 μm.

13. The method of claim 1 wherein a second surface of the ion-exchange membrane or fluid diffusion layer is adjacent to a grounded metal plate, the second surface being on the opposite side of the ion-exchange membrane or fluid diffusion layer from the first surface.

14. The method of claim 13 wherein the grounded metal plate remains stationary as the ion-exchange membrane or fluid diffusion layer moves relative to the metal plate.

15. The method of claim 1 wherein a second surface of the ion-exchange membrane or fluid diffusion layer is adjacent to a backing sheet, the second surface being on the opposite side of the ion-exchange membrane or fluid diffusion layer from the first surface.

16. The method of claim 1 wherein the electrostatically-charged catalyst slurry is sprayed onto the first surface.

17. The method of claim 1 wherein the catalyst loading of the first catalyst layer is less than about 0.8 mg/cm².

18. The method of claim 17 wherein the catalyst loading of the first catalyst layer is less than about 0.5 mg/cm².

19. The method of claim 18 wherein the catalyst loading of the first catalyst layer is less than about 0.1 mg/cm².

20. The method of claim 1 wherein the catalyst loading of the first catalyst layer is greater than about 0.015 mg/cm².

21. The method of claim 1 wherein the electrostatically-charged catalyst slurry is continuously applied onto the first surface.
